(19) United States
(12) Patent Application Publication
(10) Pub. No.: US 2006/0119973 A1
(43) Pub. Date: Jun. 8, 2006

(54) Read/write head apparatus and method

(75) Inventor: John M. Jamail, Waltham, MA (US)

Correspondence Address: HAHN LOESER & PARKS, LLP, One GOJO Plaza, Suite 300, AKRON, OH, 44311-1076, US

(73) Assignee: TranSpectral System LLC

(21) Appl. No.: 11/006,152

(22) Filed: Dec. 7, 2004

(51) Int. Cl. G11B 21/02; G11B 15/12; G11B 5/02

(52) U.S. Cl. 360/75; 360/55; 360/63

(57) ABSTRACT

Systems and methods for writing and reading digital information to and from tracks on a platter side of an electromagnetic disk drive system are disclosed. Embodiments of the present invention provide a plurality of read elements and write elements in fixed positions, with respect to tracks of a magnetic disk of the electromagnetic disk drive system. There is a one-to-one correspondence between read and write elements and tracks. As a result, many tracks may be written to and/or read from simultaneously on a single platter side of the magnetic disk, providing increased data access rates.

### CROSS-REFERENCE TO RELATED APPLICATIONS/INCORPORATION BY REFERENCE

U.S. patent application Ser. No. 09/704,282 filed on Nov. 1, 2000, is incorporated herein by reference in its entirety.

### TECHNICAL FIELD

Certain embodiments of the present invention relate to data storage devices. More particularly, certain embodiments of the present invention relate to read/write head technology of electromagnetic disk drives.

### BACKGROUND OF THE INVENTION

Magnetic hard disk drives are typically used by computers to store an operating system and information generated by the users. Magnetic hard disk drives work using a technology referred to as magnetic recording. Magnetic hard disk drives come in different sizes and form factors and use various disk diameters such as, for example, 3.5 inches. A conventional hard disk drive has a spinning platter on which an electromagnetic signature is written by a read/write head. Later, when the same information is requested, the read/write head searches the disk for the signature.

A magnetic hard disk drive has one or more platters. The platters store digital information in magnetic form. A concentric ring of magnetic bits on a side of the platter constitutes a track which is typically divided into sectors (e.g., 512 sectors). A sector of a track is defined with magnetic marking and an identification number. A cylinder is a group of tracks (one track from each side of a platter) having the same radius. Magnetic hard disk drives having multiple platters form cylinders across the multiple platters.

In operation, a magnetic hard disk drive system receives data in binary form from a host computer. To write to a platter, the binary data is typically converted into a current in a head coil. The current in the head coil reverses direction when the binary data is a “1” and stays the same when the binary data is a “0”. As the platter spins, the interaction of the current with the magnetic media of a platter side results in a magnetization of the magnetic media. The direction of the magnetization is a function of the direction of the current in the coil. As the platter spins, the coil must “fly” very close to the surface of the platter (e.g., a few nanometers) to effectively write digital data to a track on a side of the platter.

To read from a platter, current may be excited in a head coil when the head coil senses changes in the magnetization of the platter. The sensed changes in magnetization are converted to voltage pulses which are interpreted as “1's” and “0's” of the digital data being read. Again, as the platter spins, the coil must “fly” very close to the surface of the platter (e.g., a few nanometers) to effectively read digital data from a track on a side of the platter.

Today, a head of a magnetic hard disk drive typically includes a magneto-resistive head or a giant magneto-resistive head for reading and a thin-film inductive head for writing. A giant magneto-resistive head is similar to a magneto-resistive head but is much more sensitive. Also, there is typically one pair of read and write heads for each side of a platter. The read/write head combination can only read from or write to one track at a time. The read/write head is typically suspended above a platter using a slider and an actuator arm. A voice coil actuator is typically used to move the actuator arm when the head is accessing data from a particular sector of a particular track.

A self-pressurized air-bearing design concept is typically used for the slider to keep the read/write head close to the surface of the platter without actually touching the platter. For example, when a magnetic hard disk drive is turned on, the platter (i.e., disk) starts spinning. As the disk spins, air pressure builds up between the slider and the disk and the slider starts flying at, for example, a few dozen nanometers above the disk surface.

Magneto-resistive head design is based on the ability of certain metals to change resistivity in the presence of a magnetic field. As a magneto-resistive head passes along a track of a magnetic disk (i.e., platter side), the changes in magnetic field due to the encoded binary data on the magnetic media of the disk causes the resistance of the magneto-resistive head to change. As a result, the changes is resistance are sensed and interpreted as “1's” and “0's” of the encoded binary data.

A thin film inductive head is typically made of thin layers of magnetic material which are wrapped in a fine wire. A magnetic field is induced across a gap in one end of the head when a current passes through the wire. The induced magnetic field is used to change the orientation of magnetic particles on the platter, generating patterns of stored binary data. Previously, inductive heads have also been used as read heads since passing a coil above a magnetic field on the platter induces a current in the coil (i.e., wrapped wire). However, magneto-resistive and giant magneto-resistive heads are typically more sensitive for the purpose of reading from the platter.

A platter typically has two sides which may be used for magnetic recording. Therefore, one read/write head combination is used for one side and another is used for the opposite side. A typical magnetic hard disk drive may have several platters with a read/write head and slider/actuator for each side of each platter. As a result, data can be read from or written to only one track at a time for a given platter side.

Standard interfacing systems for today's hard drives (e.g., the Small Computer System Interface or SCSI) typically have maximum transfer rates of around 40 Megabytes per Second per drive.

Further limitations and disadvantages of conventional, traditional, and proposed approaches will become apparent to one of skill in the art, through comparison of such systems and methods with the present invention as set forth in the remainder of the present application with reference to the drawings.

### BRIEF SUMMARY OF THE INVENTION

An embodiment of the present invention comprises an apparatus for writing and reading digital information to and from tracks on a platter side of an electromagnetic disk drive system. The apparatus comprises an arrangement of read/write modules, being positionally fixed within an electromagnetic disk drive system, to write and read digital information to and from a plurality of tracks of a platter side of the electromagnetic disk drive system. The arrangement is configured to provide one read/write module for each track of the plurality of tracks of the platter side.

Another embodiment of the present invention comprises an apparatus for writing and reading digital information to and from tracks on a platter side of an electromagnetic disk drive system. The apparatus comprises a first arrangement of write modules, being positionally fixed within an electromagnetic disk drive system, to write digital information to a plurality of tracks of a platter side of the electromagnetic disk drive system. The first arrangement is configured to provide one write module for each track of the plurality of tracks of the platter side. The apparatus also includes a second arrangement of read modules, being positionally fixed within the electromagnetic disk drive system, to read digital information from the plurality of tracks of the platter side of the electromagnetic disk drive system. The second arrangement is configured to provide one read module for each track of the plurality of tracks of the platter side.

A further embodiment of the present invention comprises an electromagnetic disk drive system. The system comprises an electromagnetic storage subsystem including a spinnable magnetic disk platter to store digital information. The system also includes an input/output subsystem interfacing between the electromagnetic storage subsystem and a host computer. The system further includes a write subsystem including one write module for each track of each side of the platter to write digital information to each side of the platter. The system also comprises a read subsystem including one read module for each track of each side of the platter to read digital information from each side of the platter.

Another embodiment of the present invention comprises an electromagnetic disk drive system. The electromagnetic disk drive system comprises an electromagnetic storage subsystem including a spinnable magnetic disk platter to store digital information. The system further comprises an input/output subsystem interfacing between the electromagnetic storage subsystem and a host computer. The system also includes a read/write subsystem including one read/write module for each track of each side of the platter to read and write digital information from and to each side of the platter.

A further embodiment of the present invention comprises a method to simultaneously read data from and write data to a same platter side of a magnetic disk in an electromagnetic disk drive system. The method comprises writing first digital information to at least a first track of a platter side of a magnetic disk using at least a first write module of a first fixed arrangement of write modules, wherein the first fixed arrangement of write modules includes a single write module for each track of the magnetic disk. The method further includes reading second digital information from at least a second track of the platter side of the magnetic disk using at least a first read module of a second fixed arrangement of read modules, wherein the second fixed arrangement of read modules includes a single read module for each track of the magnetic disk such that the reading occurs simultaneously with the writing.

Still another embodiment of the present invention comprises a method to simultaneously read data from and write data to a same platter side of a magnetic disk in an electromagnetic disk drive system. The method comprises writing first digital information to at least a first track of a platter side of a magnetic disk using at least a first read/write module of a fixed arrangement of read/write modules, wherein the fixed arrangement of read/write modules includes a single read/write module for each track of the magnetic disk. The method further includes reading second digital information from at least a second track of the platter side using at least a second read/write module of the fixed arrangement of read/write modules such that the reading occurs simultaneously with the writing.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates a first exemplary embodiment of an electromagnetic disk drive system, in accordance with various aspects of the present invention.

FIG. 2 is a flowchart of a first embodiment of a method to simultaneously read data from and write data to a same platter side of a magnetic disk in the electromagnetic disk drive system of FIG. 1, in accordance with various aspects of the present invention.

FIG. 3 illustrates a second exemplary embodiment of an electromagnetic disk drive system, in accordance with various aspects of the present invention.

FIG. 4 is a flowchart of a second embodiment of a method to simultaneously read data from and write data to a same platter side of a magnetic disk in the electromagnetic disk drive system of FIG. 3, in accordance with various aspects of the present invention.

FIG. 5A illustrates a first exemplary embodiment of a magnetic disk configuration having two platter sides that can be read from and written to, in accordance with various aspects of the present invention.

FIG. 5B illustrates a second exemplary embodiment of a magnetic disk configuration having two platter sides that can be read from and written to, in accordance with various aspects of the present invention.

FIG. 6 illustrates a first exemplary embodiment of a stack of platters used in an electromagnetic disk drive system, in accordance with various aspects of the present invention.

FIG. 7 illustrates a second exemplary embodiment of a stack of platters used in an electromagnetic disk drive system, in accordance with various aspects of the present invention.

### DETAILED DESCRIPTION OF THE INVENTION

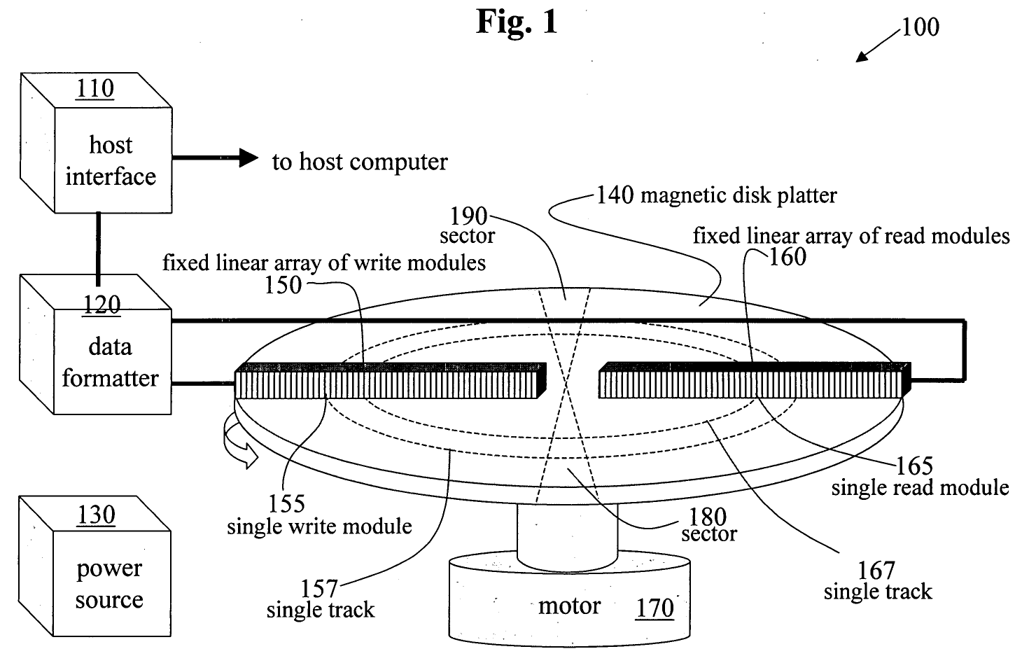

FIG. 1 illustrates a first exemplary embodiment of an electromagnetic disk drive system 100, in accordance with various aspects of the present invention. The system 100 includes a host interface 110, a data formatter/multiplexer 120, a power source 130, a spinnable magnetic disk platter 140, a fixed linear array (i.e., a fixed arrangement) of write modules 150, a fixed linear array (i.e., a fixed arrangement) of read modules 160, and a motor 170. The host interface 110 and the data formatter/multiplexer 120 constitute an input/output subsystem of the electromagnetic disk drive system 100. The spinnable magnetic disk platter 140, the motor 170, and the power source 130 constitute an electromagnetic storage subsystem of the electromagnetic disk drive system 100. The motor 170 is used to spin or rotate the disk platter 140. The fixed linear array of write modules 150 constitutes a write subsystem and the fixed linear array of read modules 160 constitutes a read subsystem of the electromagnetic disk drive system 100.

The host data interface 110 (a digital circuit) operates as a high-speed, mass storage interface from the system 100 to a host computer (not shown). That is, the host data interface 110 provides the transfer of digital information (i.e., binary data) from the host computer to the system 100 and vice versa. For example, the host data interface 110 may comprise an industry standard interface in the one to five gigabytes per second range. An enabling technology for the host data interface 110 may include Fibre Channel, both in single and multiple links, for example.

The data formatter/multiplexer 120 (a digital circuit) interfaces between the host data interface 110 and write subsystem 150 and the read subsystem 160 to buffer data for disassembly and reassembly to and from the write subsystem 150 and the read subsystem 160. The data formatter/multiplexer 120 multiplexes data into parallel channels corresponding to the parallel (concentric) tracks on the disk platter 140. The data formatter/multiplexer 120 provides a massive data interconnect to the read and write subsystems. High speed digital design methodology and materials are used to realize the data formatter/multiplexer 120. The multiplexing functions can be provided by field programmable gate array (FPGA) and application specific integrated circuit (ASIC) technology, for example. Buffering functions can be provided by static read only memory (SROM) technology, for example.

The storage subsystem includes a spinning magnetic disk 140. The spinning disk provides a stable rotating surface.

The fixed linear array of write modules 150 comprises a plurality of inductive elements (e.g., thin film inductive heads) for writing to the magnetic disk platter 140. The fixed linear array of write modules 150 is fixed in position and is configured such that there is one write module (e.g., 155) for each track on a side of the platter 140. The fixed linear array of write modules 150 is a massively parallel write subsystem that allows all tracks on a side of the platter 140 to be written to simultaneously, in accordance with an embodiment of the present invention. Since the fixed linear array of write modules 150 is fixed, no slider, actuator arm, or voice coil actuator is needed to move the fixed linear array of write modules 150. As an alternative, a subset of tracks may be written to simultaneously. The one-to-one correspondence between tracks and write modules (i.e., inductive elements) allows only one write module to write to only one track. That is, each write module is dedicated to a separate, single track. As a result, a large amount of data may be written to the platter 140 in a relatively short time interval compared to conventional disk drives which have a single write head per platter side. The input/output subsystem (110, 120) is designed to handle the increased data access rates provided by the write subsystem 150.

The fixed linear array of read modules 160 comprises a plurality of magneto-resistive (MR) elements or giant MR elements for reading from the magnetic disk platter 140. GMR technology has dramatically increased the density of data packing onto a hard disk platter. The fixed linear array of read modules 160 is fixed in position and is configured such that there is one read module (e.g., 165) for each track on a side of the platter 140. The fixed linear array of read modules 160 is a massively parallel read subsystem that allows all tracks on a side of the platter 140 to be read from simultaneously, in accordance with an embodiment of the present invention. As an alternative, a subset of tracks may be read from simultaneously. Since the fixed linear array of read modules 160 is fixed, no slider, actuator arm, or voice coil actuator is needed to move the fixed linear array of read modules 160. The one-to-one correspondence between tracks and read modules (i.e., MR or GMR elements) allows only one read module to read from only one track. That is, each read module is dedicated to a separate, single track. As a result, a large amount of data may be read from the platter 140 in a relatively short time interval compared to conventional disk drives which have a single read element per platter side. In accordance with an alternative embodiment of the present invention, the fixed linear array of read modules 160 comprises a plurality of inductive elements optimized for reading. The input/output subsystem (110, 120) is designed to handle the increased data access rates provided by the read subsystem 160.

In accordance with an embodiment of the present invention, data sorting on the platter may follow standard guidelines of a regular hard drive. Each bit of data has an address which is stored on a disk data map. The data map has all of the standard redundancies of a conventional electromagnetic hard drive. Partitions work similarly since they are based in software, and not hardware. Data storage in this aspect is identical to that of a conventional hard drive. The system 100 also supports FAT, FAT32, HPFS and NTFS file allocation methods. FAT stands for File Allocation Table and is the standard by which many computers run. FAT 32 is a relatively new allocation method that reduces the minimum cluster size for partitions and is an advancement of the FAT method. HPFS stands for High Performance File System and is a special allocation method designed by IBM to run on their OS/2 operating system. NTFS stands for New Technology File System and is a special allocation method designed by Microsoft to run on their Windows NT operating system.

However, in accordance with other embodiments of the present invention, reading or writing from/to multiple tracks simultaneously results in data being organized on the magnetic disk platter 140 in a manner that is efficient for such an accessing methodology. For example, if data is being written to the disk platter 140 simultaneously using all write modules to write to all tracks, then data will be written to a certain sector number of all tracks before going to a next sector number, in accordance with an embodiment of the present invention. This assumes that all of the write modules of the fixed linear array of write modules 150 are aligned along a certain radius as shown in FIG. 1, corresponding to a same sector number for all tracks when the disk platter is rotated to a certain position.

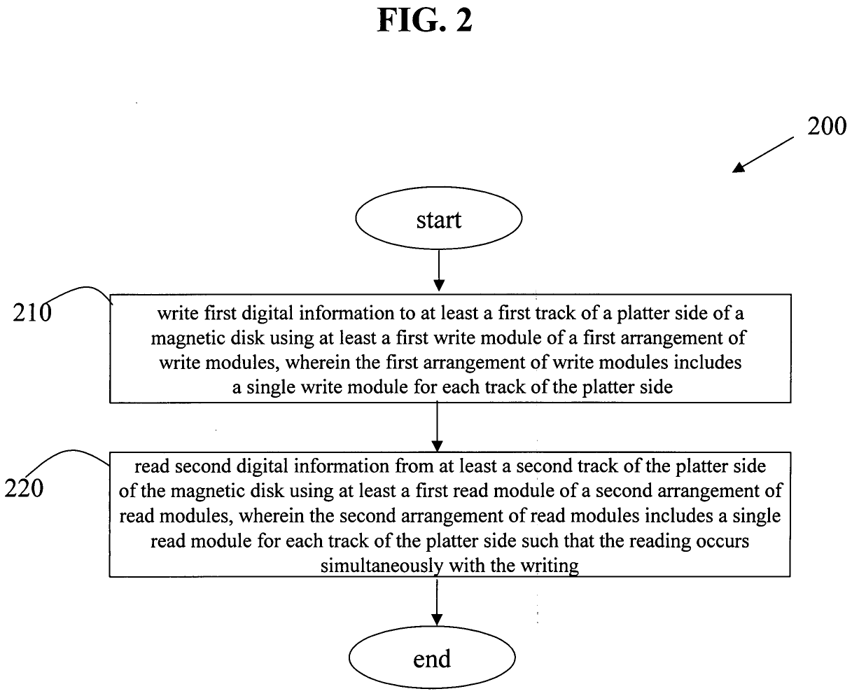

FIG. 2 is a flowchart of a first embodiment of a method 200 to simultaneously read data from and write data to a same platter side of a magnetic disk in the electromagnetic disk drive system of FIG. 1, in accordance with various aspects of the present invention. In step 210, first digital information is written to at least a first track of a platter side of a magnetic disk using at least a first write module of a first fixed linear array of write modules, wherein the first fixed linear array of write modules includes a single write module for each track of the platter side. In step 220, second digital information is read from at least a second track of the platter side of the magnetic disk using at least a first read module of a second fixed linear array of read modules, wherein the second fixed linear array of read modules includes a single read module for each track of the platter side such that the reading occurs simultaneously with the writing.

For example, the single write module 155 can be writing first digital information to the single track 157 while the single read module 165 is simultaneously reading second digital information from a different single track 167. As another example, the fixed linear array of write modules 150 can be writing a first plurality of digital information to 128 tracks while the fixed linear array of read modules is simultaneously reading a second plurality of digital information from 64 different tracks. It can be seen that a certain flexibility of writing to certain tracks while simultaneously reading from certain other tracks is provided by the system of FIG. 1.

However, when writing to certain sectors on certain tracks, the sectors that may be simultaneously read from are limited by the sectors being written to. For example, referring to FIG. 1, if the fixed linear array of write modules 150 are aligned with a sector 180, then the fixed linear array of read modules 160 will simultaneously be aligned with the sector 190 which is 180 degrees opposite the sector 180 due to the orientation of the fixed linear array 150 with respect to the fixed linear array 160. As a result, only digital information contained in the sector 190 may be simultaneously read while writing to the sector 180. However, data may be written to a certain sector number of certain tracks during a first time interval and then other data may be read from a certain different sector number of certain tracks during a second time interval by rotating the disk platter 140 between the two time intervals.

Other orientations of the fixed linear array of write modules 150 with respect to the fixed linear array of read modules 160 are possible as well, in accordance with various embodiments of the present invention. For example, the fixed linear array of read modules 160 could be oriented at an angle of 90 degrees with respect to the fixed linear array of write modules 150. Also, the fixed linear array of write modules 150 and/or the fixed linear array of read modules 160 do not have to be aligned along a same radius as in FIG. 1. For example, the fixed arrangement of write modules could be staggered such that each write module is not only aligned with a different track but is also aligned with a different sector number, in accordance with an embodiment of the present invention. Such a configuration may afford certain efficiencies not available in the linear array arrangement of FIG. 1.

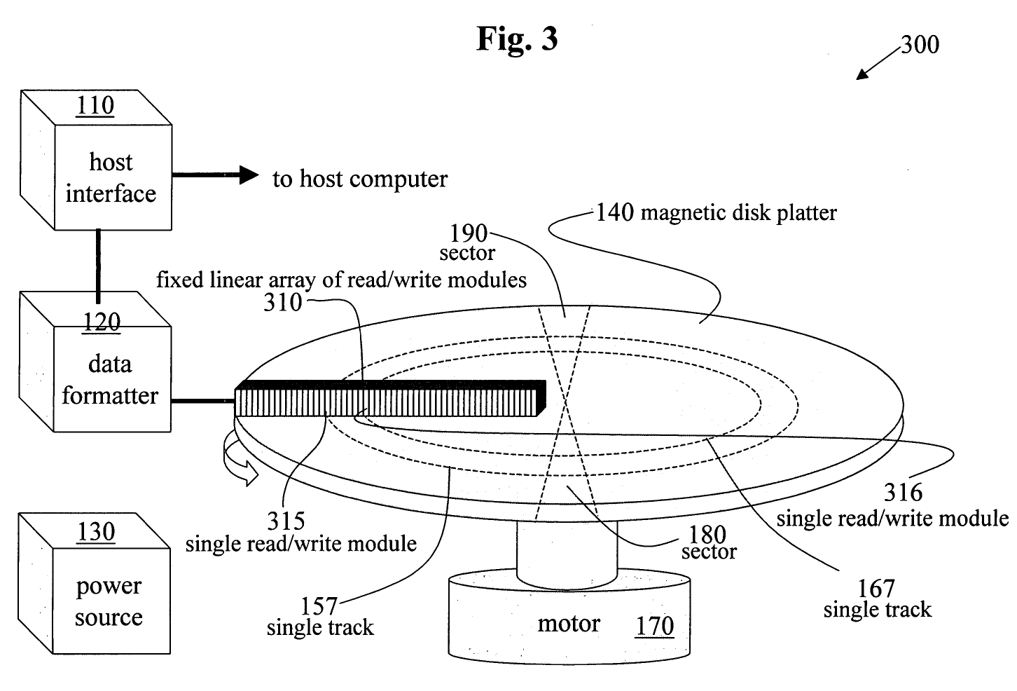

FIG. 3 illustrates a second exemplary embodiment of an electromagnetic disk drive system 300, in accordance with various aspects of the present invention. The system 300 is essentially the same as the system 100 of FIG. 1 except that, instead of a fixed linear array of write modules 150 and a fixed linear array of read modules 160 as in FIG. 1, the system 300 includes a fixed linear array (i.e. fixed arrangement) of read/write modules 310. The fixed linear array of read/write modules 310 constitutes a read/write subsystem. The data formatter/multiplexer 120 interfaces between the host data interface 110 and the read/write subsystem 310 to buffer data for disassembly and reassembly to and from the read/write subsystem 310.

The fixed linear array of read/write modules 310 is fixed in position and is configured such that there is one read/write module (e.g., 315) for each track on a side of the platter 140. The fixed linear array of read/write modules 310 is a massively parallel read/write subsystem that allows all tracks on a side of the platter 140 to be written to simultaneously or read from simultaneously, in accordance with an embodiment of the present invention. Since the fixed linear array of read/write modules 310 is fixed, no slider, actuator arm, or voice coil actuator is needed to move the fixed linear array of read/write modules 310. As an alternative, a subset of tracks may be written to simultaneously, or a subset of tracks may be read from simultaneously. Also, a first subset of tracks may be written to while a second subset of tracks is simultaneously being read from. The one-to-one correspondence between tracks and read/write modules allows only one read/write module to write to or read from only one track. That is, each read/write module is dedicated to a separate, single track. As a result, a large amount of data may be written to and/or read from the platter 140 in a relatively short time interval compared to conventional disk drives which have a single read/write head per platter side.

Each read/write module of the fixed linear array of read/write modules 310 includes an inductive element (e.g., thin film inductive head) for writing to the magnetic disk platter 140, and a MR element or a GMR element for reading from the magnetic disk platter 140. In accordance with an alternative embodiment of the present invention, each read/write module of the fixed linear array of read/write modules 310 includes a first inductive element optimized for reading, instead of a MR element or a GMR element and a second inductive element optimized for writing. In accordance with a further alternative embodiment of the present invention, each read/write module of the fixed linear array of read/write modules 310 includes a single inductive element for both reading and writing. As a result, only one fixed linear array of modules is used for both reading and writing whereas, in the system 100 of FIG. 1, two fixed linear arrays of modules are used. The input/output subsystem (110, 120) is designed to handle the increased data access rates provided by the read/write subsystem 310.

Reading or writing to multiple tracks simultaneously results in data being organized on the magnetic disk platter 140 in a manner that is efficient for such an accessing methodology. For example, if data is being written to the disk platter 140 simultaneously using all read/write modules to write to all tracks, then data will be written to a certain sector number of all tracks before going to a next sector number, in accordance with an embodiment of the present invention. This assumes that all of the read/write modules of the fixed linear array of read/write modules 310 are aligned along a certain radius as shown in FIG. 3, corresponding to a same sector number for all tracks when the disk platter is rotated to a certain position.

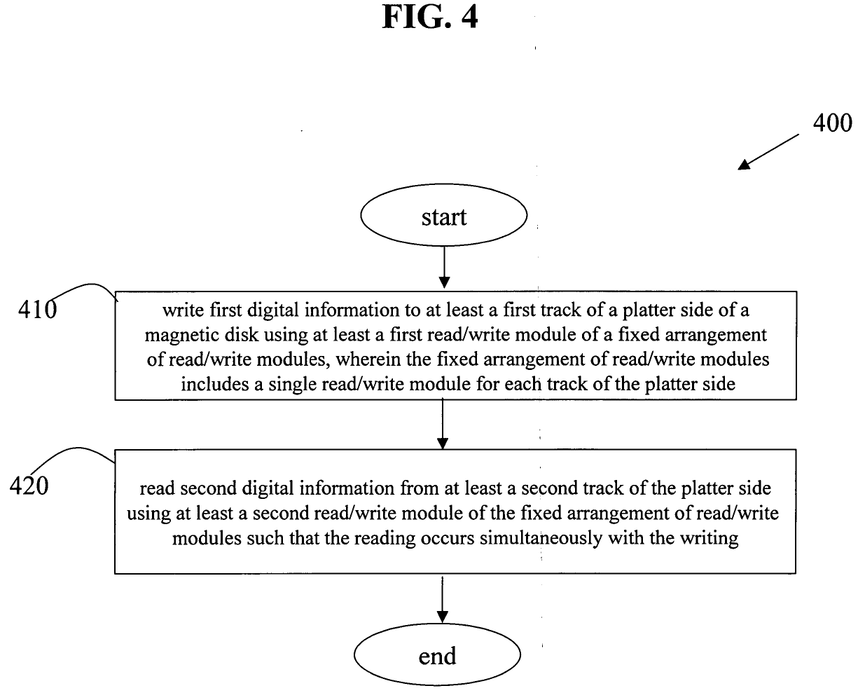

FIG. 4 is a flowchart of a second embodiment of a method 400 to simultaneously read data from and write data to a same platter side of a magnetic disk in the electromagnetic disk drive system of FIG. 3, in accordance with various aspects of the present invention. In step 410, first digital information is written to at least a first track of a platter side of a magnetic disk using at least a first read/write module of a fixed linear array of read/write modules, wherein the fixed linear array of read/write modules includes a single read/write module for each track of the platter side. In step 420, second digital information is read from at least a second track of the platter side using at least a second read/write module of the fixed linear array of read/write modules such that the reading occurs simultaneously with the writing.

For example, the single read/write module 315 can be writing first digital information to the single track 157 while the single read/write module 316 is simultaneously reading second digital information from a different single track 167. As another example, the fixed linear array of read/write modules 310 can be writing a first plurality of digital information to 128 tracks while reading a second plurality of digital information from 64 different tracks. It can be seen that a certain flexibility of writing to certain tracks while simultaneously reading from certain other tracks is provided by the system of FIG. 3.

However, when writing to certain sectors on certain tracks, the sectors that may be simultaneously read from are limited to the sectors being written to. For example, referring to FIG. 3, if the fixed linear array of read/write modules 310 is aligned with a sector 180, then only sector 180 may be written to and/or read from simultaneously. However, data may be written to a certain sector number of certain tracks during a first time interval and then other data may be read from a certain different sector number of certain tracks during a second time interval by rotating the disk platter 140 between the two time intervals.

The fixed linear array of read/write modules 310 do not have to be aligned along a same radius as in FIG. 3. For example, a fixed arrangement of read/write modules could be staggered such that each read/write module is not only aligned with a different track but is also aligned with a different sector number, in accordance with an embodiment of the present invention. Such a configuration may afford certain efficiencies not available in the linear array arrangement of FIG. 3.

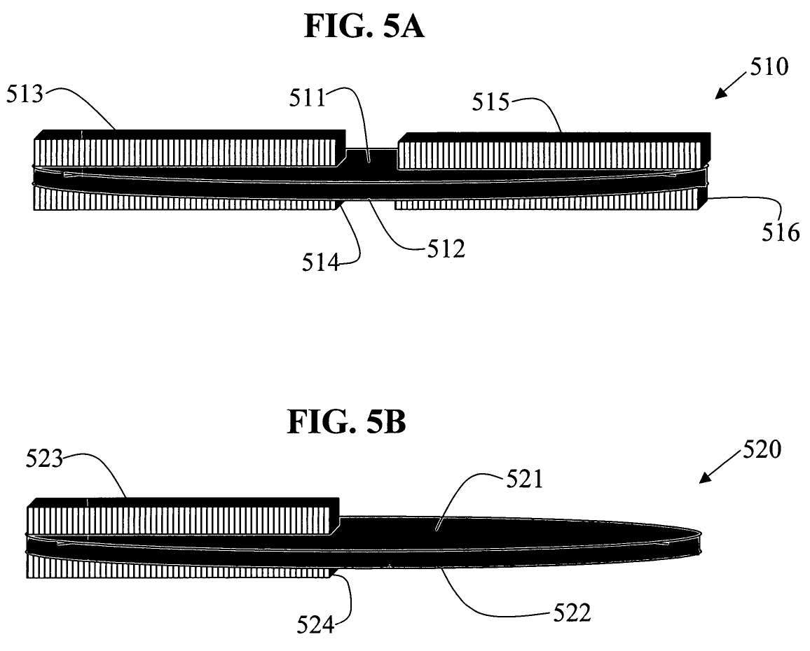

FIG. 5A illustrates a first exemplary embodiment of a magnetic disk configuration 510 having two platter sides 511 and 512 that can be read from and written to, in accordance with various aspects of the present invention. The magnetic disk configuration 510 has a first fixed linear array of write modules 513 positioned to write digital information to the first platter side 511, and a second fixed linear array of write modules 514 positioned to write digital information to the second platter side 512. Similarly, the magnetic disk configuration 510 has a third fixed linear array of read modules 515 positioned to read digital information from the first platter side 511, and a fourth fixed linear array of read modules 516 positioned to read digital information from the second platter side 512. Such a magnetic disk configuration 510 may be used in the system 100 of FIG. 1 such that both sides of the magnetic disk platter may be written to and read from, in accordance with an embodiment of the present invention.

FIG. 5B illustrates a second exemplary embodiment of a magnetic disk 520 having two platter sides 521 and 522 that can be read from and written to, in accordance with various aspects of the present invention. The magnetic disk configuration 520 has a first fixed linear array of read/write modules 523 positioned to write and read digital information to and from the first platter side 521, and a second fixed linear array of read/write modules 524 positioned to write and read digital information to and from the second platter side 512. Such a magnetic disk configuration 510 may be used in the system 300 of FIG. 3 such that both sides of the magnetic disk platter may be written to and read from, in accordance with an embodiment of the present invention.

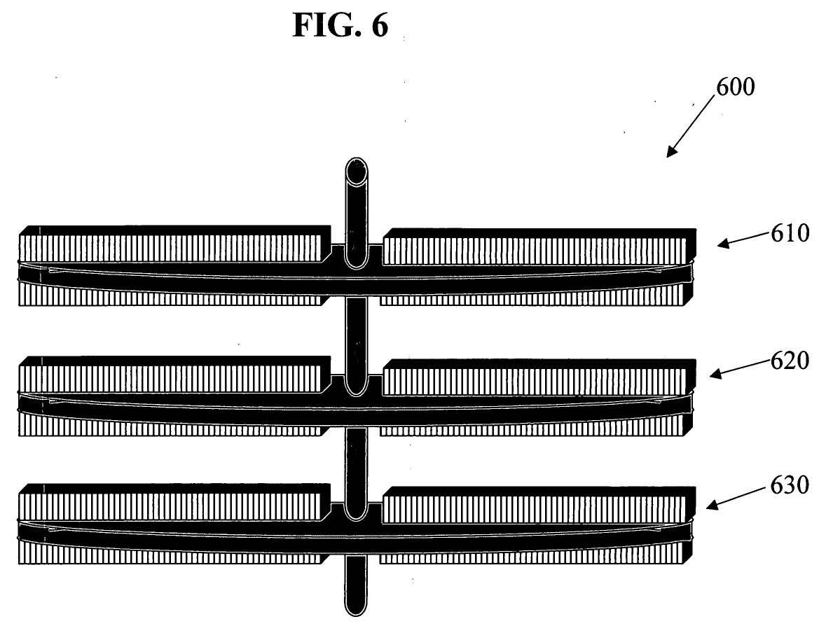

FIG. 6 illustrates a first exemplary embodiment of a stack of platters 600 used in an electromagnetic disk drive system, in accordance with various aspects of the present invention. The stack 600 includes three platters 610, 620, and 630 stacked vertically with respect to each other. Each platter is configured similarly to the magnetic disk platter configuration 510 of FIG. 5A. Such a stack of platters 600 may be used in the system 100 of FIG. 1 such that both sides of each platter 610, 620, and 630 may be written to and read from, in accordance with an embodiment of the present invention.

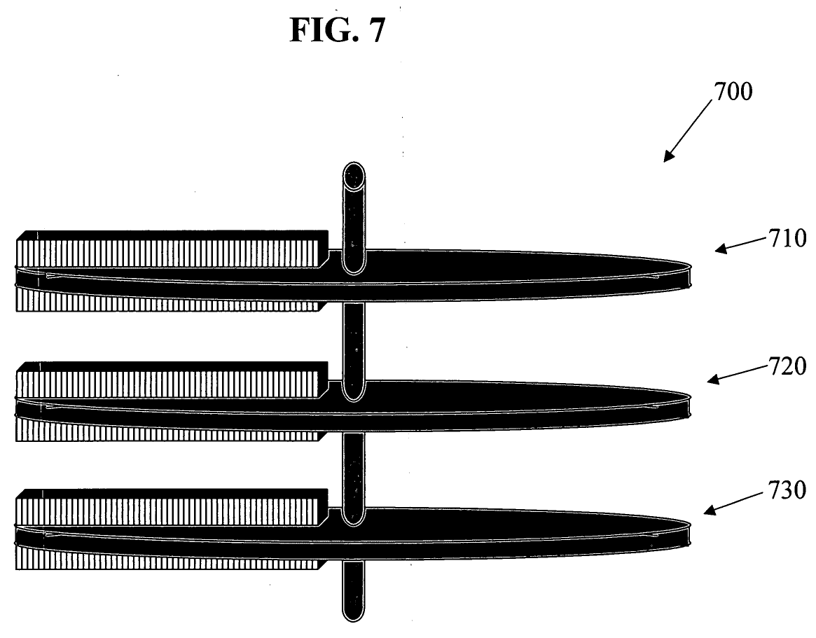

FIG. 7 illustrates a second exemplary embodiment of a stack of platters 700 used in an electromagnetic disk drive system, in accordance with various aspects of the present invention. The stack 700 includes three platters 710, 720, and 730 stacked vertically with respect to each other. Each platter is configured similarly to the magnetic disk platter configuration 520 of FIG. 5B. Such a stack of platters 700 may be used in the system 300 of FIG. 3 such that both sides of each platter 710, 720, and 730 may be written to and read from, in accordance with an embodiment of the present invention.

In accordance with other alternative embodiments of the present invention, the concept of having a plurality of read and write elements, one for each track, may be extended and applied to other technologies as well including, for example, compact disk (CD) and digital video disk (DVD) technologies.

In summary, methods and systems are disclosed for using a plurality of fixed modules for reading and writing to a plurality of tracks of a magnetic disk platter in an electromagnetic disk drive system to provide high-speed parallel access to stored data.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. An apparatus for writing and reading digital information to and from tracks on a platter side of an electromagnetic disk drive system, said apparatus comprising:
an arrangement of read/write modules, being positionally fixed within an electromagnetic disk drive system, to write and read digital information to and from a plurality of tracks of a platter side of said electromagnetic disk drive system, and wherein said arrangement is configured to provide one read/write module for each track of said plurality of tracks of said platter side.

2. The apparatus of claim 1 wherein each read/write module in said arrangement of read/write modules includes an inductive element for writing to said platter side and a magneto-resistive element for reading from said platter side.

3. The apparatus of claim 1 wherein each read/write module in said arrangement of read/write modules includes an inductive element for writing to and reading from said platter side.

4. The apparatus of claim 1 wherein each read/write module in said arrangement of read/write modules includes an inductive element for writing to said platter side and a giant magneto-resistive element for reading from said platter side.

5. The apparatus of claim 1 wherein at least two tracks of said plurality of tracks is written to or read from simultaneously.

6. The apparatus of claim 1 wherein said arrangement of read/write modules comprises a fixed linear array of read/write modules.

7. An apparatus for writing and reading digital information to and from tracks on a platter side of an electromagnetic disk drive system, said apparatus comprising:
a first arrangement of write modules, being positionally fixed within an electromagnetic disk drive system, to write digital information to a plurality of tracks of a platter side of said electromagnetic disk drive system, and wherein said first arrangement is configured to provide one write module for each track of said plurality of tracks of said platter side; and
a second arrangement of read modules, being positionally fixed within said electromagnetic disk drive system, to read digital information from said plurality of tracks of said platter side of said electromagnetic disk drive system, and wherein said second arrangement is configured to provide one read module for each track of said plurality of tracks of said platter side.

8. The apparatus of claim 7 wherein each write module of said first arrangement of write modules includes an inductive element for writing to said platter side.

9. The apparatus of claim 7 wherein each read module of said second arrangement of read modules includes a magneto-resistive element for reading from said platter side.

10. The apparatus of claim 7 wherein each read module of said second arrangement of read modules includes an inductive element for reading from said platter side.

11. The apparatus of claim 7 wherein each read module of said second arrangement of read modules includes a giant magneto-resistive element for reading from said platter side.

12. The apparatus of claim 7 wherein at least two tracks of said plurality of tracks is written to or read from simultaneously.

13. The apparatus of claim 7 wherein said first arrangement of write modules comprises a fixed linear array of write modules.

14. The apparatus of claim 7 wherein said second arrangement of read modules comprises a fixed linear array of read modules.

15. An electromagnetic disk drive system, said system comprising:
an electromagnetic storage subsystem including a spinnable magnetic disk platter to store digital information;
an input/output subsystem interfacing between said electromagnetic storage subsystem and a host computer;
a write subsystem including one write module for each track of each side of said platter to write digital information to said each side of said platter; and
a read subsystem including one read module for each track of said each side of said platter to read digital information from said each side of said platter.

16. The system of claim 15 wherein said input/output subsystem includes a host data interface to operate as a high-speed, mass storage interface from said system to said host computer.

17. The system of claim 16 wherein said input/output subsystem includes a data formatter/multiplexer, interfacing between said host data interface and said write subsystem and said read subsystem, to buffer data for disassembly and reassembly to and from said write subsystem and said read subsystem.

18. The system of claim 15 wherein said electromagnetic storage subsystem includes said spinnable magnetic disk platter, a motor, and a power source.

19. The system of claim 15 wherein each write module includes an inductive element.

20. The system of claim 15 wherein each read module includes a magneto-resistive element.

21. The system of claim 15 wherein each read module includes an inductive element.

22. The system of claim 15 wherein each read module includes a giant magneto-resistive element.

23. The system of claim 15 wherein at least two tracks of said each side of said platter are written to or read from simultaneously.

24. An electromagnetic disk drive system, said system comprising:
an electromagnetic storage subsystem including a spinnable magnetic disk platter to store digital information;
an input/output subsystem interfacing between said electromagnetic storage subsystem and a host computer;
a read/write subsystem including one read/write module for each track of each side of said platter to read and write digital information from and to said each side of said platter.

25. The system of claim 24 wherein said input/output subsystem includes a host data interface to operate as a high-speed, mass storage interface from said system to said host computer.

26. The system of claim 25 wherein said input/output subsystem includes a data formatter/multiplexer, interfacing between said host data interface and said read/write subsystem, to buffer data for disassembly and reassembly to and from said read/write subsystem.

27. The system of claim 24 wherein said electromagnetic storage subsystem includes said spinnable magnetic disk platter, a motor, and a power source.

28. The system of claim 24 wherein each read/write module includes an inductive element for writing.

29. The system of claim 24 wherein each read/write module includes a magneto-resistive element for reading.

30. The system of claim 24 wherein each read/write module includes an inductive element for reading.

31. The system of claim 24 wherein each read/write module includes a giant magneto-resistive element for reading.

32. The system of claim 24 wherein at least two tracks of said each side of said platter are written to or read from simultaneously.

33. A method to simultaneously read data from and write data to a same platter side of a magnetic disk in an electromagnetic disk drive system, said method comprising:
writing first digital information to at least a first track of a platter side of said magnetic disk using at least a first write module of a first fixed arrangement of write modules, wherein said first fixed arrangement of write modules includes a single write module for each track of said platter side; and
reading second digital information from at least a second track of said platter side of said magnetic disk using at least a first read module of a second fixed arrangement of read modules, wherein said second fixed arrangement of read modules includes a single read module for each track of said platter side such that said reading occurs simultaneously with said writing.

34. The method of claim 33 wherein each write module of said first fixed arrangement of write modules includes an inductive element for writing to said platter side.

35. The method of claim 33 wherein each read module of said second fixed arrangement of read modules includes a magneto-resistive element for reading from said platter side.

36. The method of claim 33 wherein each read module of said second fixed arrangement of read modules includes an inductive element for reading from said platter side.

37. The method of claim 33 wherein each read module of said second fixed arrangement of read modules includes a giant magneto-resistive element for reading from said platter side.

38. A method to simultaneously read data from and write data to a same platter side of a magnetic disk in an electromagnetic disk drive system, said method comprising:
writing first digital information to at least a first track of a platter side of said magnetic disk using at least a first read/write module of a fixed arrangement of read/write modules, wherein said fixed arrangement of read/write modules includes a single read/write module for each track of said platter side; and
reading second digital information from at least a second track of said platter side using at least a second read/write module of said fixed arrangement of read/write modules such that said reading occurs simultaneously with said writing.

39. The method of claim 38 wherein each read/write module in said fixed arrangement of read/write modules includes an inductive element for writing to said platter side and a magneto-resistive element for reading from said platter side.

40. The method of claim 38 wherein each read/write module in said fixed arrangement of read/write modules includes an inductive element for writing to and reading from said platter side.

41. The method of claim 38 wherein each read/write module in said fixed arrangement of read/write modules includes an inductive element for writing to said platter side and a giant magneto-resistive element for reading from said platter side.
